(19) United States
(12) Patent Application Publication
(10) Pub. No.: US 2021/0303318 A1
(43) Pub. Date: Sep. 30, 2021

(54) Method to generate a familiar user interface based on coarse-grained specification

(71) Applicant: Shruthi Raghavan, San Jose, CA (US)

(72) Inventor: Shruthi Raghavan, San Jose, CA (US)

(21) Appl. No.: 16/834,330

(22) Filed: Mar. 30, 2020

(51) Int. Cl. G06F 9/451; G06F 3/048; G06F 40/279; G06N 3/04; G06N 3/08

(52) U.S. Cl. CPC G06F 9/451; G06F 3/048; G06N 3/088; G06N 3/0454; G06F 40/279

(57) ABSTRACT

Generative adversarial neural networks are good in producing images automatically from noise. These images are becoming more and more realistic. The above mechanism has been extended to apply to generation of a user interface such as a webpage. But the starting point would be a coarse arrangement of required UI elements. A user specifies user interface elements on a coarse grid layout. The finer geometry of the UI elements which is both pleasing and familiar to look at, would be generated by a neural network. A particular variety of generative adversarial networks called SR-GAN is very well suited to this. The neural network would be trained on existing most popular web sites to understand the way coarse arrangement of web page elements correspond to actual dimensions of those elements, the same way, a high resolution image could be generated from low resolution image.

### CROSS REFERENCE TO RELATED APPLICATION

This application claims the benefit of U.S. Provisional Application No. 62/888,547

### BACKGROUND OF THE INVENTION

UI development includes two phases. The first phase is making a wireframe prototype which basically represents a visual representation of the looks and is usually output in html/css. The second phase is adding behavioral elements to the static pages, and defining the flow between different frames. The wireframe phase is not tough but needs the experience of a UI designer to give it a familiar and clean look and feel that is pleasing to the eye. That process takes time.

### DETAILED DESCRIPTION OF SOME EMBODIMENTS

In one embodiment, the developer will define the macro look and feel by specifying what elements would be present in what page, while the tool correctly positions and styles the micro features to make it pleasing and familiar to the eye.

In one embodiment, an super resolution generative adversarial network (SRGAN) may be used to improve the coarse element specification to fine tuned specification that is familiar to the eye.

In another embodiment a different neural network which also enables super resolution with the aid of a generative adversarial neural network may be used such as EDSR, SRCNN, ESRGAN etc, or may not be a generative adversarial neural network at all, replaced with something more simpler and easier to train.

The input is represented as a grid matrix with x and y dimension representing the 2 dimensional canvas. The 3^{rd} dimension represents different UI elements. For e.g if the matrix is of dimension 28×28×32. That means there are 32 possible UI elements. The value of the matrix say ‘v’ at point say x,y,z point represents: There are “v” elements of zth UI element at point x,y in the canvas.

In another embodiment the matrix could be a sparse matrix with some other dimensions.

Hence the number of input layers for the convolutional neural network is x*y*z, where z is the number of possible UI elements. The same would be the output layer dimensions. The generator would take the approximate positions and generate a matrix that represents the actual position in a fine grid matrix.

The discriminator would classify this as real or fake based on grid matrices obtained from real world UI page data. The output of the discriminator is back propagated to the generator network. Hence with more and more data generator gets really good at generating familiar UI interface layouts for every page. The discriminator also gets better and better at identifying real world UI from auto generated one.

In another embodiment a intermediate VGG network, that may be pretrained to classify user interface look and feel, could be used for better calibration to improve accuracy of generator

In one embodiment there is an graphical user interface that allows the user to specify the approximate UI elements and its approximate positions and dimensions

In [009], the trained neural network mentioned in [001] to [004] may be used to convert the coarse matrix in to fine matrix

In another embodiment of [009], a natural language translation mechanism may be used such as a pretrained neural network, similar in architecture to seq2seq or GLOVE to translate user intent to actual html/JavaScript or a similar UI programming language, including element names, tags and its corresponding valid syntax.

In another embodiment of [009] a grid layout may be used to obtain the user intention

In another embodiment of [001]-[004] additional metrics describing look and feel of design may be used to better align user expectation with output

Referring to FIG. 1 is illustrated an exemplary flow of an exemplary system for training generative adversarial neural network to generate a fine grid matrix describing position, alignment and style of user interface elements, based on user specification on a coarse grid layout. As shown in FIG. 1, in one embodiment, there can be a graphical user interface that uses natural language translation methods to translate user intention in natural language to programmatically correct syntax of UI programming languages.

It may be appreciated by a person with ordinary skill in the art, in light of and in accordance with the teachings of the present invention any compatible form of Neural network model may be employed for natural language to software input translation.

It may be appreciated by a person with ordinary skill in the art, in light of and in accordance with the teachings of the present invention any compatible machine learning algorithms may be employed, for example, support vector machines and the like.

It may be appreciated by a person with ordinary skill in the art, in light of and in accordance with the teachings of the present invention any other compatible natural languages and or other types of software languages

In various embodiments, the system described herein may include a designated software that may be executed using a local computer, on cloud, and other like systems as may be appreciated by a person with ordinary skill in the art, in light of and in accordance with the teachings of the present invention.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

The invention has been described above by way of illustration, and the specific embodiments disclosed are not intended to limit the invention to the particular forms disclosed.

### BRIEF DESCRIPTION OF DRAWINGS

FIG. 1 describes two sessions. In training session, web pages are scraped and the relative sizes, attributes and positions of user interface elements are learnt by the neural network. In generation session, the trained model is used to transform coarse grained user input in to fine grained user interface elements

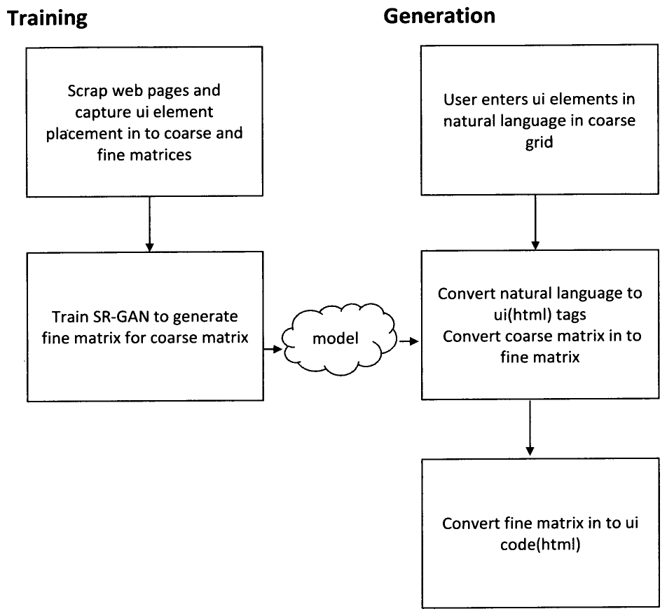

What is claimed is:

1. A method to represent the geometry of UI elements by a UI matrix where two dimensions represent two-dimensional space and the third dimension represents different types of UI element

2. In another embodiment a user interface may be used with a grid layout where user may enter the desired elements in a coarse grained layout, which could be converted in to a matrix using [1.]

3. In another embodiment, the proposed method also includes training a generative adversarial neural network to generate a fine grained matrix describing position, alignment and style of UI elements from a coarse grained description

4. In another embodiment, a discriminator neural network, may be used to improve the accuracy of the generator neural network, which would simultaneously be trained to discriminate generated page from a real world page

5. In another embodiment the neural network in claim 3. may be replaced by a different neural network to improve resolution such as Enhanced deep residual network (EDSR), Super resolution generative adversarial network (SRGAN), Enhanced SR GAN (ESRGAN), Super resolution convolutional neural network (SRCNN), or any other neural network intended to improve image resolution

6. In another embodiment of claim 2, the user interface that captures user's intent may use a natural language to front end programming language translator.

7. Another embodiment of 6, could use a combination of machine translation neural network such as seq2seq network, along with vector representation of commonly used words describing user interface elements
